(19) United States
(12) Patent Application Publication
(10) Pub. No.: US 2003/0066853 A1
(43) Pub. Date: Apr. 10, 2003

(54) Mounting apparatus for all terrain vehicles

(76) Inventor: Matthew Paul Hebert, Rayne, LA (US)

Correspondence Address: TED M. ANTHONY, Perret Doise, Post Office Drawer 3408, Lafayette, LA, 70502, US

(21) Appl. No.: 09/973,506

(22) Filed: Oct. 9, 2001

(51) Int. Cl. B62J 7/02; B62J 7/08

(52) U.S. Cl. 224/401; 224/454; 224/456

(57) ABSTRACT

The invention relates to a mounting apparatus which can be used to quickly and easily mount implements and/or accessories to storage racks of all-terrain vehicles (“ATV's”). A slot is provided on the item to be attached to the ATV storage rack. A mounting bracket is provided which has a concave section, a flat section and a bore passing through the flat section. The mounting bracket is positioned so that the concave section is engaged against the lower surface of a tubular member of an ATV storage rack, the flat section of the mounting bracket is in close proximity to the slot on the item to be mounted, and the bore passing through the flat section of the mounting bracket is aligned with the slot. A bolt or other fastener is disposed through said slot and mounting bracket and secured in place.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### FIELD OF THE INVENTION

The invention generally relates to the field of recreational vehicles such as all terrain vehicles (ATVs). More particularly the invention relates to a mounting apparatus which is engageable with existing storage racks on ATV's. More particularly still, the invention relates to a mounting apparatus which can be used to quickly and easily mount implements and/or accessories to ATV's, and which facilitates quick and easy removal of such implements and/or accessories.

### BACKGROUND OF THE INVENTION

Recreational or all terrain vehicles such as ATV's have become increasingly popular as a mode of transportation, particularly for a wide variety of off-road activities. Typically, ATV's are integrally equipped with one or more storage racks which are commonly found at the front and/or rear of such vehicles. Such racks generally consist of a horizontal supporting surface formed by a series of roughly parallel tubular steel members which are spaced in a manner to allow items, such as storage containers, work implements or other accessories to be placed on said racks and attached thereto.

Often, it is desirable to attach items to said ATV's. When a storage container, work implement or other accessory or item is to be mounted on an ATV rack, various mounting means are used to connect said load to the ATV rack. Such existing mounting means are often inconvenient, and sometimes interfere with the use of the container, work implement or other accessory item. Additionally, due to the common upstanding rear end portion on ATV racks, items having a length greater than the distance from the rear of an ATV's driver's seat to the upstanding rear end portion of the tubular rack are not conveniently accommodated by such mounting means.

With the increasing popularity of ATV's, the common storage rack, as described, is inefficient for transporting certain items which may be needed for various activities. This inefficiency has prompted modifications or additions to existing storage racks and, more particularly, development of different means for affixing items to such racks. For example U.S. Pat. No. 5,878,929, issued to Leonard, describes a support device for retaining either a bow adapter or a gun rack which is mounted to the rear rack of an ATV. The device utilizes an anchoring member allowing the passage of respective U-bolts to enable releasable attachment. Similarly, U.S. Pat. No. 5,595,333, issued to is Boston, describes a releasable attachment used in conjunction with the storage rack for retaining a bow, rifle, shotgun or other similar implement. Neither of these mounting means provide the benefits associated with the present invention.

In an ideal scenario, items (such as accessories or work implements) mounted on ATV storage racks would be specifically designed to fit or mate with that particular type or style of storage rack. However, in many instances, such mountable items are made by different manufacturers than said ATV storage racks. Thus, said items often do not mate in precise fashion with underlying ATV storage racks. Moreover, it is often very desirable and beneficial to switch or interchange such mountable items between two or more ATV's having different sizes and shapes of storage racks. As a result, means for mounting items to ATV storage racks often must be used in connection with several different types of storage racks, including racks which do not precisely fit the configuration of the item to be mounted thereon. Thus, such mounting means should ideally be functional with as many different sizes, shapes and configurations of ATV storage racks as possible.

Even when a particular mounting apparatus is specifically designed to mate with or fit a particular ATV storage rack design, use of such mounting means can be cumbersome and difficult. Using existing mounting means, ATV operators are often required to reach into tight spaces between ATV storage racks and the items being attached thereto. Often the mounting means must be installed from awkward angles, leaving little or no room for tightening of bolts or other attachment devices.

As a result, it is desirable to provide an apparatus for securely mounting items (such as accessories or work implements) to ATV storage racks. Further, it is desirable that said mounting means facilitate attachment of such items to ATV storage racks having a wide variety of different shapes, sizes and configurations. It is also desirable that said mounting means be adapted to facilitate quick attachment of items to storage racks of ATV's, as well as quick removal of said items from said ATV's.

### SUMMARY OF THE INVENTION

It is a primary object of the present invention to increase the overall capability of attaching items to the storage rack of an ATV or similar off-road vehicle. Specifically, it is a primary object of the present invention to provide a means for quickly, easily and securely mounting an item such as an accessory or work implement to the storage rack of an ATV. Likewise, it is also a primary object of the present invention to provide a means for mounting an item to the storage rack of an ATV permitting quick removal of such item.

The mounting apparatus of the present invention utilizes two or more slots which are included as part of an item to be affixed to the storage rack of an ATV, or attached thereto. In the preferred embodiment, said slots are formed by slotted members which extend outward from the items to be mounted, and which include a generally linear slot which can accommodate a bolt or other similar fastener. Moreover, in the preferred embodiment, said slotted members are welded or integrally attached to said item to be mounted. Alternatively, it should be noted that such a slot could also be formed by structural elements of the mountable item itself.

The mounting apparatus of the present invention further includes a mounting bracket. Said mounting bracket includes a curved, concave section which is shaped to fit around the outer circumference of the tubular members of an ATV storage rack. At the opposite end of said mounting bracket from said concave section is a relatively flat section. A bore extends through the flat section of said mounting bracket. In one embodiment, the inner surface of said bore is threaded. In the preferred embodiment, a nut or other internally threaded piece is attached to the lower surface of said mounting bracket and aligned with said bore.

An item to be mounted to an ATV storage rack is first placed upon said rack. The slotted members of the present invention are positioned so that they are situated in close proximity to the tubular members of the storage rack. The linear slots of said slotted members are aligned roughly parallel the tubular members of said ATV storage rack.

Once the item to be mounted has been so positioned, mounting brackets are used to anchor the item to said ATV storage rack. Specifically, the concave ends of said mounting brackets are placed under the tubular members of the ATV storage rack, with the flat (opposite) ends of said mounting brackets in close proximity to said slotted members. In this position, the bores of said mounting brackets are aligned with the linear slots of said slotted members. Threaded bolts are placed through the slots of said slotted members, and extend into the bores of said mounting brackets. Said bolts are then rotated to engage the threads associated with said bores. The bolts are tightened until the mounting brackets are held tightly in place, thereby resulting in the mounted item being securely attached to the ATV storage rack.

The linear slots of the slotted members are provided to allow flexibility in the precise positioning of mounting brackets and said bolts. Because numerous different designs/configurations of storage racks exist, different racks may have obstructions or elements at different locations which could impede positioning of a mounting bracket. Thus, it is often advantageous to be able to avoid such obstructions by shifting the position of said mounting bracket relative to said slotted member. The slotted member permits said mounting brackets to be shifted along the length of said slot so that obstructions can be avoided.

One advantage of the described carrier mounting apparatus is that increased versatility and functionability of a recreational or other vehicle can be achieved without requiring significant modifications to the vehicle.

Another advantage is that the described mounting apparatus does not require modifications to a vehicle or to a vehicle storage rack, while also being easily installed and removed, as needed.

These and other objects, features and advantages of the present invention all become apparent from the following narrative and the accompanying drawings.

### BRIEF DESCRIPTION OF THE DRAWINGS

FIG. 1 is a side perspective of a typical recreational vehicle or ATV;

FIG. 2 is side perspective view of the rear portion of a standard storage rack of a recreational vehicle;

FIG. 3 is a side perspective view of a typical storage box mounted on the rear storage rack of a recreational vehicle using the mounting apparatus of the present invention;

FIG. 4 is a top perspective view of a mounting bracket of the mounting apparatus of the present invention;

FIG. 5 is a side view of a mounting bracket of the mounting apparatus of the present invention;

FIG. 6 is a top perspective view of the slotted member of the mounting apparatus of the present invention; and

FIG. 7 is a side cut-away view of an implement mounted to the storage rack of a recreational vehicle using the mounting apparatus of the present invention.

### DETAILED DESCRIPTION

The following description will be focused upon uses of the present invention in connection with all terrain vehicles and the like. However, it will be readily apparent to one of adequate skill that the inventive concepts described herein can be applied to other suitable vehicles, including farm vehicles such as tractors or other similar vehicles.

Furthermore, and depending on the vehicle, the present accessory can alternately be attached, for example, to a front or otherwise disposed rack of the vehicle having adequate supporting structure. The discussion also utilizes such terms as “top”, “bottom”, “lateral”, “side”, and the like throughout. These terms are only intended to provide a frame of reference with respect to the accompanying drawings and are not intended to be limiting of the present invention.

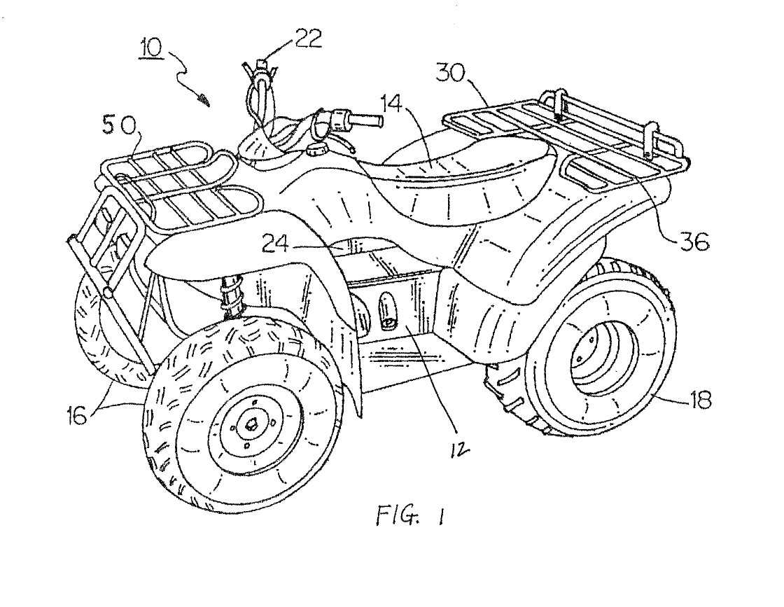

Turning first to FIG. 1, a typical all terrain recreational vehicle (ATV) 10 is shown. In terms of background, the ATV 10 includes a compact motorized vehicle frame 12 which includes a saddle-like rider's seat 14 with a fuel tank 24 being disposed in front of and beneath the seat. The vehicle 10 further includes a pair of front balloon tires 16 and a pair of rear balloon tires 18 and a steering mechanism comprising a column (not shown) and handle bars 22 permitting the rider to turn the front tires. Specific details relating to the overall mechanical features of the vehicle are known to those in the field and require no further discussion as to the present invention. Furthermore, other similar vehicles, such as so-called “three-wheelers” having only a single front tire and a pair of rear tires, (not shown) are among such as described in U.S. Pat. No. 5,083,632, which is herein incorporated by reference in its entirety are intended to be included among those vehicles covered by the carrier accessory of the present invention.

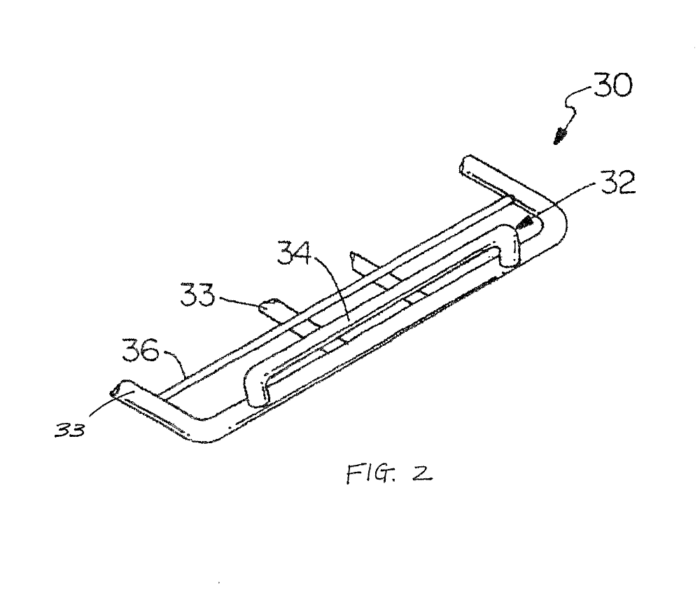

Referring to FIGS. 1 and 2, the vehicle 10 further includes a rear storage rack 30 attached to the vehicle frame 12 which, according to this embodiment, includes an interconnected series of respective sets of parallel and spaced longitudinal and transverse tubular members 33, 36. These tubular sections 33, 36 define a horizontal supporting surface. The storage rack 30 also includes a raised rear section 32 having an upper transverse rear supporting rod 34 located at the rearmost portion of the rack. As shown and noted above, the vehicle 10 may also include a front storage rack 50 having similar features.

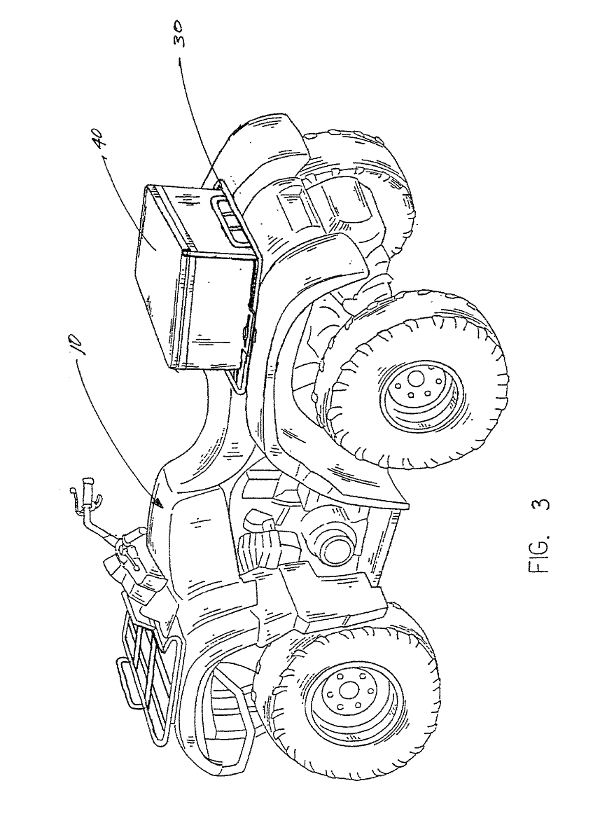

FIG. 3 depicts a side perspective view of load 40 secured to the rear storage rack of a recreational vehicle using the mounting apparatus of the present invention. Although for purposes of illustration, the mounted item in question is a storage box, it should be noted that any implement or other accessory can be secured to said mounting rack using the mounting apparatus of the present invention. For example, the possible implements which can be secured to a recreational vehicle include, but are in no way limited to, utility baskets, liquid storage tanks, farming implements and the like.

Still referring to FIG. 3, load 40 is placed upon the upper surface of rear tubular storage rack 30 of recreational vehicle 10. The mounting apparatus of the present invention is used to secure said implement 40 to said rear storage rack 30, and to ensure that said implement remains securely mounted in place. During typical use, recreational vehicles are often driven across unpaved and/or uneven terrain. As a result, said vehicles and the loads carried thereon can be subjected to bouncing or jostling, and must remain securely mounted to the vehicle for optimum use.

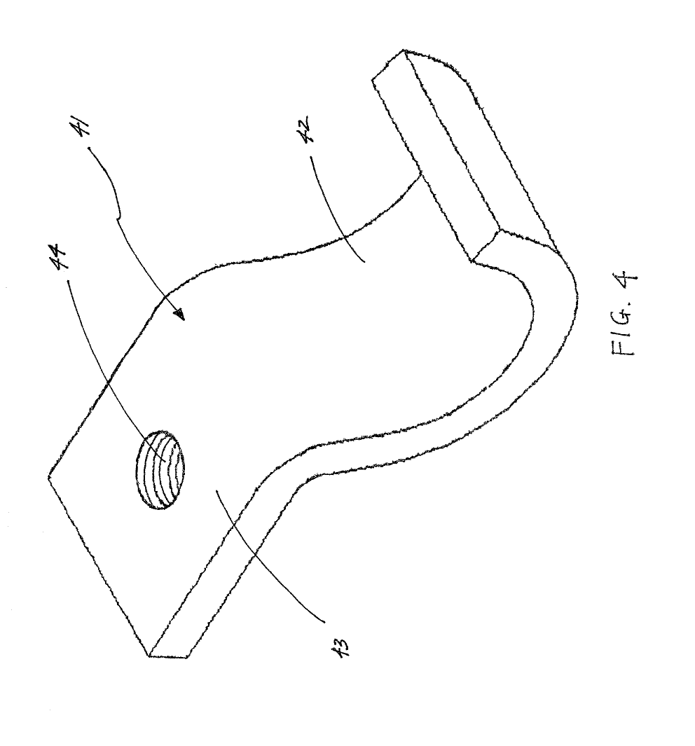

FIG. 4 depicts mounting bracket 41 of the mounting apparatus of the present invention. Mounting bracket 41 has curved, concave portion 42 at one end, and flat portion 43 at the opposite end. Bore 44 passes through flat portion 43 of lower mounting bracket 41 while the inner surface of bore 44 is threaded.

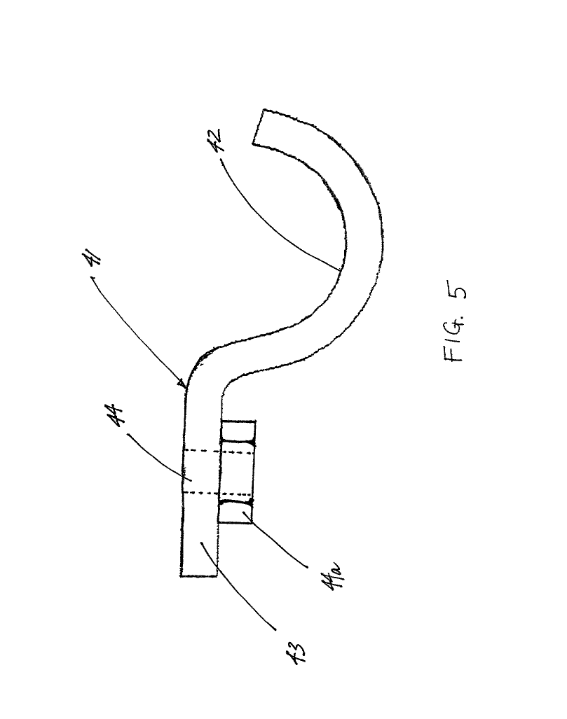

FIG. 5 is a side cut-away view of mounting bracket 41 of the present invention. As previously discussed, mounting bracket 41 has curved, concave portion 42 at one end, and flat portion 43 at the other end. Bore 44 passes through flat portion 43. In the preferred embodiment, nut 44a is welded or otherwise attached to the lower surface of mounting bracket 41 such that the bore of nut 44a is aligned with bore 44. A bolt inserted through bore 44 can threadably mate with threads on the inner surface of nut 44a. Although concave portion 42 does not have a particular radius of curvature, it must be of sufficient size to fit around the circumference of a tubular member of an ATV storage rack.

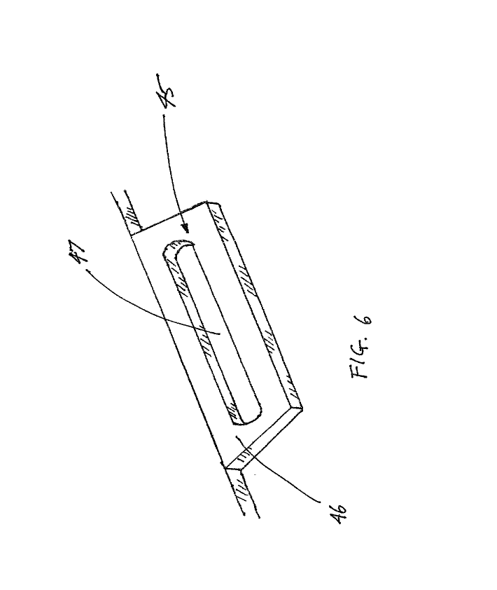

FIG. 6 is a top perspective view of a slotted member 45 of the mounting apparatus of the present invention. In the preferred embodiment, slotted member 45 is formed of a roughly flat body 46. Linear slot 47 extends through said flat body 46. Although there is no predetermined length of linear slot 47, said slot should be long enough to permit positioning of mounting bracket 41 as desired around any obstructions which may be present related to ATV storage rack 30.

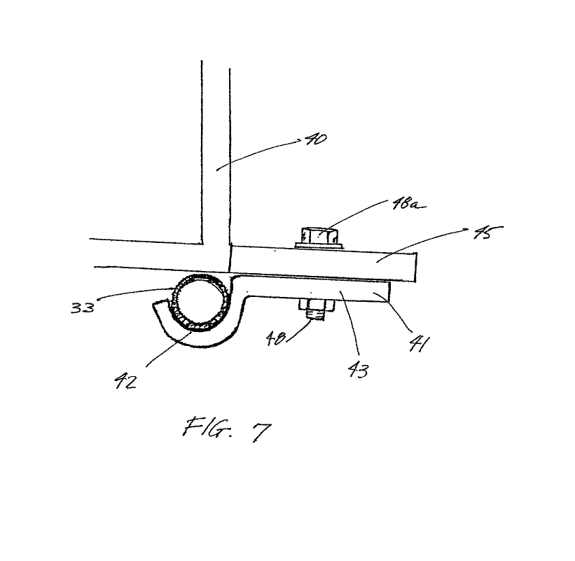

FIG. 7 is a side cut-away view of an implement mounted to the storage rack of an ATV using the mounting apparatus of the present invention. Load 40 rests upon the upper surface of tubular member 33 of ATV storage rack 30. Slotted member 45 is affixed to load 40 at or near the base of load 40 in close proximity to tubular member 33. Mounting bracket 41 is situated below slotted member 45; concave section 42 of mounting bracket 41 is placed under tubular member 33, while flat portion 43 of mounting bracket 41 is positioned immediately below slotted member 45.

In this position, bore 44 is aligned with linear slot 47 (not shown from this view). Bolt 48 having head 48a is inserted through linear slot 47 of slotted member 45 and threadably connected with the threads on the inner surface of nut 44a under mounting bracket 41. As bolt 48 is tightened, mounting bracket 41 is drawn toward slotted member 45, resulting in load 40 being securely fastened to tubular member 33.

In operation, item 40 is placed upon the upper surface of tubular ATV storage rack 30. Two or more slotted members 45, which are attached at or near the base of item 40, are positioned in close proximity to tubular members 33 of said ATV storage rack 30. In this position, each linear slot 47 of said slotted members 45 are aligned roughly parallel to, and just outside of, said tubular members 33. Once mountable item 40 and slotted members 45 are so positioned, mounting brackets 41 are installed. The concave sections 42 of each mounting bracket 41 are placed immediately beneath tubular members 33, such that said tubular members 33 fit within the “scoops” formed by said concave sections. Meanwhile, flat sections 43 of each mounting bracket 41 are placed immediately below slotted members 45, such that bores 44 which extend through said mounting brackets are aligned with linear slots 47 of slotted members 45. Bolts 48 are inserted through linear slots 47 and into bores 44, and screwed into place. As bolts 48 are tightened, mounting brackets 41 are drawn tight against slotted members 45 and tubular members 33 of the ATV storage rack, thereby resulting in secure mounting of said item 40 to ATV storage rack 30. In the event that an obstruction is present which prevents positioning of mounting bracket 41 at a particular location along a slotted member 45, said mounting bracket can be moved in either direction along the length of linear slot 47 in order to avoid said obstruction before bolt 48 is inserted and mounting bracket 41 is fastened in place. Although any number of said mounting devices of the present invention can be used to securely mount an item to an ATV storage rack, it is envisioned that in most instances two or more such mounting devices are required for this purpose.

Though the preceding has been described in terms of a single preferred embodiment, it will be readily apparent that various modifications and changes can be made which are well within the spirit and scope of the invention as defined by the following claims.

It can therefore be seen that a novel mounting apparatus has been provided for an all-terrain vehicle which may be used to mount or secure an item upon and to the support rack of an all-terrain vehicle. The means of attaching the implement to the support rack of the all-terrain vehicle not only positively secures the implement to the vehicle, but does not interfere with the normal use of said implement.

Although the implement is illustrated and described as being secured to a support rack at the rear of the all-terrain vehicle, said implement obviously could be mounted on a support rack positioned at the forward end of the all-terrain vehicle, as desired.

What is claimed:

1. An apparatus for mounting an item to the storage rack of an all terrain vehicle comprising:
a. A bracket having a concave section to partially engage a tubular member of said storage rack; and
b. Means for fastening said bracket to the item to be mounted.
